(19) United States
(12) Patent Application Publication
(10) Pub. No.: US 2007/0187370 A1
(43) Pub. Date: Aug. 16, 2007

(54) METHOD AND APPARATUS FOR POSITIONING ELECTRODES RELATIVE TO A WELDING GUN

(76) Inventors: Keith Hochhalter, Inverness, IL (US); Florinel Ciubotaru, Minnetonka, MN (US); Paul Michael Romslo, Robbinsdale, MN (US)

Correspondence Address: DORSEY & WHITNEY LLP;INTELLECTUAL PROPERTY DEPARTMENT, SUITE 1500, 50 SOUTH SIXTH STREET, MINNEAPOLIS, MN, 55402-1498, US

(21) Appl. No.: 11/562,139

(22) Filed: Nov. 21, 2006

Related U.S. Application Data
(60) Provisional application No. 60/738,622, filed on Nov. 21, 2005.

(51) Int. Cl. B23K 11/11

(52) U.S. Cl. 219/86.32

(57) ABSTRACT

A method and apparatus for positioning electrodes relative to a welding gun and for providing equalization relative to the electrodes of an opposed welding device. The apparatus includes a servo driven linear actuator and a controller integrated into a single housing. The method is directed to a control for the servo actuator which maintains substantially equal pressures between the electrodes and the workpiece during a welding operation.

### BACKGROUND OF THE INVENTION

1. Field of the Invention

The present invention relates generally to a method and apparatus for positioning electrodes relative to a welding gun for providing equalization relative to the electrodes of an opposed electrode welding device such as a spot welding device. More particularly, the invention relates to a method and apparatus for positioning a stationary electrode of an opposed electrode welding device such as spot welding in contact with a workpiece and/or for maintaining contact between the workpiece and the stationary and moveable electrode with substantially equal forces throughout the welding process.

2. Description of the Prior Art

In general, opposed electrode resistance welding involves positioning a pair of electrodes on opposite sides of a workpiece and passing a current between the electrodes and through the workpiece to weld the two members of the workpiece together. Although the present invention has potential applicability to various opposed electrode welding processes, it has particular applicability to what is commonly referred to as resistance spot welding.

A typical spot welding gun or device includes a main welding gun body with a stationary electrode whose position is fixed relative to the main gun body and a moveable electrode whose position is moveable relative to the main gun body. A typical spot welding gun further includes a driving or equalization actuator for moving the main gun body, including the stationary and moveable electrodes, and a pressing or squeeze actuator for moving the moveable electrode relative to the main gun body, and thus relative to the stationary electrode. During use, a workpiece comprised of two or more metal members to be welded together are positioned between the welding tips of the stationary and moveable electrodes. The welding tips of the stationary and moveable electrodes are then moved toward the workpiece via the equalization and squeeze actuators so that the electrode tips are properly positioned and in contact with opposite sides of the workpiece. The pressure element of the resistance weld is then preferably applied via the squeeze actuator.

This positioning of the electrodes in contact with the workpiece and maintaining such contact with substantially equal force on the different layers of the workpiece is commonly referred to as “equalization”. Thus, in the process of spot welding, “equalization” is the process used to “float” the spot welding gun main body and the rigidly attached stationary electrode relative to the workpiece during the positioning and welding process. Equalization also functions to overcome various tolerances and positional errors or inconsistencies. These include tolerances in the tooling that present the workpiece to the robot, tolerances in the workpiece geometry itself, positional errors related to the presentation of the welding gun to the workpiece by the robot and changes in electrode tip location as electrode tips are consumed. Without equalization, uneven forces are applied to the different layers of the workpiece. This often results in workpiece deformation and/or excessive melting/expulsion through one of the workpieces which in turn leads to a poor quality weld and one of the primary causes of assembly line shutdown.

Various equalization systems are common in resistance spot welding. Examples include pneumatic equalization systems which utilize air cylinders as the driving force, mechanical systems which utilize one or more springs as the driving force and servo equalization systems which utilize a servo motor as the driving force. A principal shortcoming of both pneumatic and mechanical systems is the inability of the systems to automatically compensate for welding gun wear and/or contamination and welding gun orientation. As welding guns wear and become contaminated, adjustments in springs and air pressure are required to provide the desired “float”. Further, if the welding gun is oriented in multiple positions for various welds, the equalizer is unable to accurately counteract the weight of the gun without spring or air pressure adjustment. Even if a middle or compromise spring or air pressure can be reached between multiple orientations, this typically leaves only narrow margins to accommodate load characteristic changes during wear and contamination of the welding gun. Still further, pneumatic systems require compressed air for driving the equalization actuator. Because many plants are attempting to remove the expense of compressed air from the spot welding process, this is a severe shortcoming of pneumatic systems.

Some of the shortcomings of pneumatic and mechanical equalization systems have been overcome by servo driven squeeze actuators and by servo driven equalization actuators such as that shown in U.S. Pat. No. 5,988,486. While present servo driven systems, for the most part, overcome the multiple orientation issues of pneumatic and mechanical systems, limitations continue to exist in the ability of current servo systems to accurately position the stationary electrode in contact with or relative to the workpiece without damaging or adversely affecting the workpiece and the ability of the gun body and stationary electrode to float during the positioning and pressure actuation of the squeeze actuator.

Accordingly, a need continues to exist for a method and apparatus for controlling the positioning of electrodes in an opposed electrode welding system and particularly to an improved method and apparatus for locating the stationary electrodes relative to the workpiece and for equalizing the electrode force relative to a workpiece in a resistance spot welding application.

### SUMMARY OF THE INVENTION

In contrast to the prior art, the present invention provides a method and apparatus for positioning electrodes in an opposed electrode welding system and in particular, a method and apparatus for detecting contact of the stationary electrode with the workpiece and for providing equalization between the stationary and moveable electrodes in a spot welding system.

The spot welding system with which the invention has particular applicability includes a main gun body, a stationary electrode fixed to the main gun body and a moveable electrode connected with the main gun body, but moveable relative to the main gun body and the stationary electrode. The spot welding system of the present invention also includes a squeeze actuator between the main gun body and the moveable electrode and an improved equalization actuator between the main gun body and a system support. In the preferred embodiment, the squeeze actuator is a servo driven linear actuator, although other forms of actuators could be utilized as well. In the preferred embodiment, the equalization actuator is a servo driven linear actuator and includes an integrated actuator, motor, driver, controller and feedback in a single housing. A further feature of the equalization actuator is that the integrated controller controls the servo drive and thus the actuator, in a manner which allows the main gun body and stationary electrode to “float” during actuation of the squeeze actuator so that substantially equal forces are maintained by the electrodes against the workpiece, regardless of system tolerances, positioning errors or gun orientation.

One embodiment of a method of controlling the equalization actuator in accordance with the present invention generally includes monitoring the following error of the servo drive and positioning the stationary electrode relative to the workpiece and equalizing the pressure of the two electrodes on the workpiece in response to or based on such following error observations. More specifically, the method includes accelerating the servo drive of the equalization actuator, and thus the fixed electrode, to a preset speed and then monitoring the following error (or more specifically an increase thereof) of the servo drive to determine contact between the fixed electrode and the workpiece. After contact with the workpiece has been established and forward movement of the fixed electrode terminated, the following error is used to establish a forward bias to the servo drive, and thus the fixed electrode, so that forces of the moveable and fixed electrodes on the workpiece are equalized during positioning and pressure actuation of the squeeze actuator.

A further method of controlling the equalization actuator in accordance with the present invention includes maintaining the actuator and thus the fixed electrode in a “float” position or mode by determining the equalization motor torque needed to maintain such electrode in its “float” position. More specifically, the method includes determining the equalizing torque needed to maintain the electrode in a “float” condition by recording the output current needed to move the electrode in both a position direction and a negative direction and averaging such recorded currents.

Accordingly, it is an object of the present invention to provide a method and apparatus for controlling the electrode positioning relative to a workpiece in an opposed electrode welding system.

Another object of the present invention is to provide a method and apparatus for controlling the position of electrodes in a resistance spot welding system.

Another object of the present invention is to provide a method and apparatus for providing equalization relative to the electrodes in a spot welding system.

These and other objects of the present invention will become more apparent with reference to the drawings, the description of the preferred embodiment and method and the appended claims.

### DESCRIPTION OF THE DRAWINGS

FIG. 1 is a side view of a welding robot with a “C” style weld gun mounted thereon and showing the weld gun in a variety of positions.

FIG. 2 is a side view of a welding robot with an “X” style weld gun mounted thereon and showing the weld gun in a variety of positions.

FIG. 3 is a side view showing the internal actuation and control components of an equalization actuator in accordance with the present invention.

FIG. 4 is a flow chart showing one embodiment of a method in accordance with the present invention for controlling the equalization actuator.

FIG. 5 is a graph showing the change in following error of the servo drive as a function of time during operation of the equalization actuator.

FIG. 6 is a side view showing the internal actuation and control components of a further embodiment of an equalization actuator in accordance with the present invention.

FIG. 7 is a flow chart showing a further embodiment of a method in accordance with the present invention for controlling the equalization actuator.

### DESCRIPTION OF THE PREFERRED EMBODIMENT AND METHOD

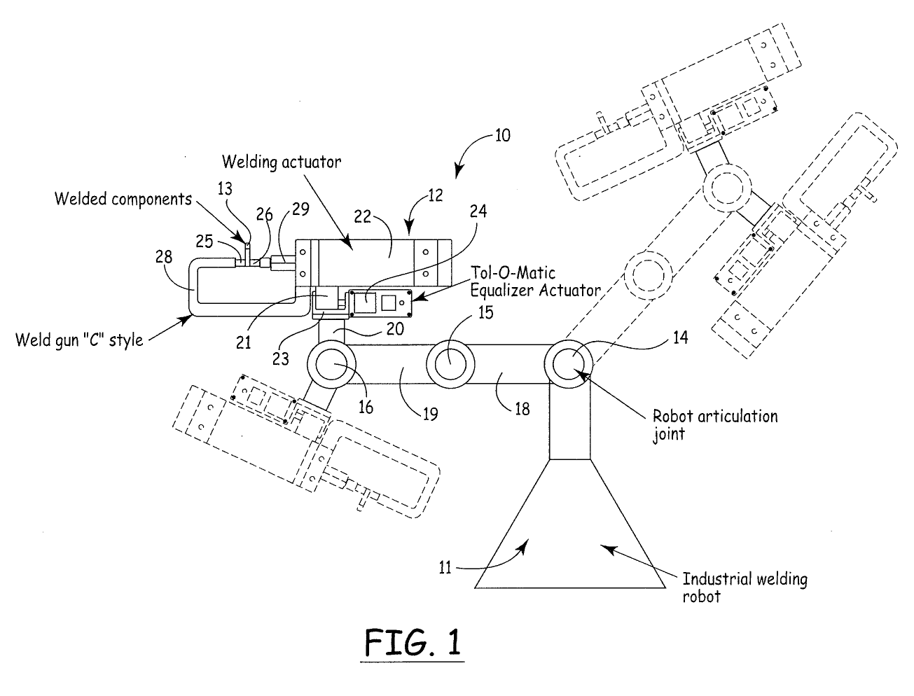

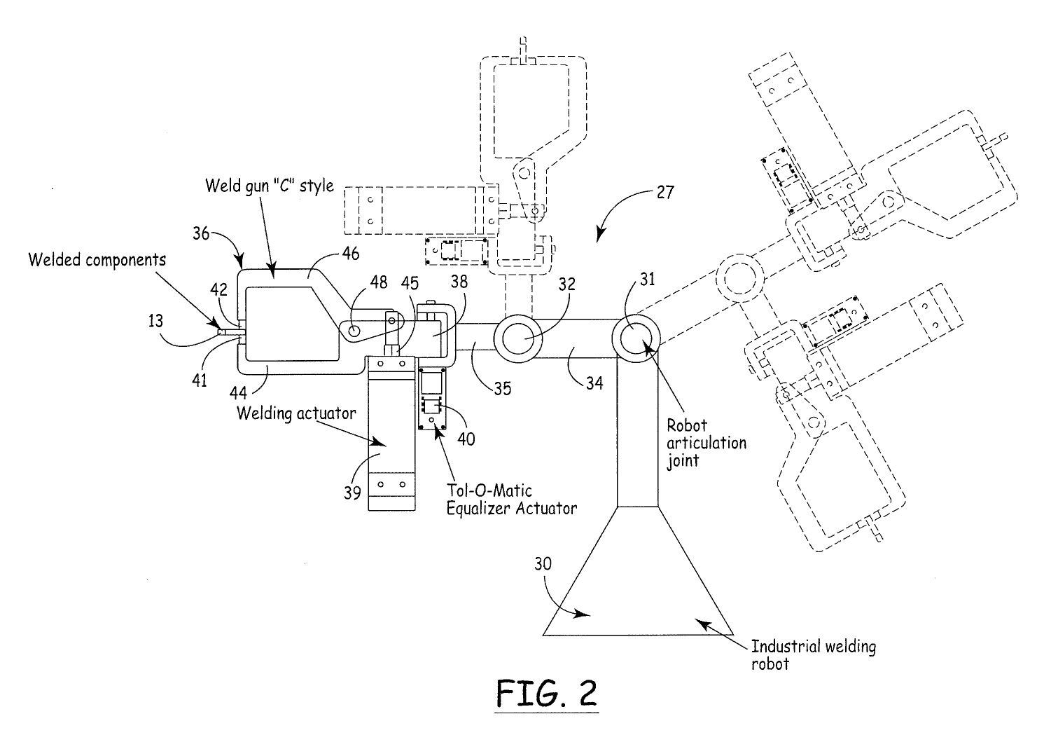

The present invention is directed to a method and apparatus for equalization relative to a welding gun and more specifically, to a method and apparatus for detecting contact of the fixed or stationary electrode with the workpiece and for equalizing the forces of the fixed and moveable electrodes of an opposed electrode welding device against the workpiece. Although the present invention has potential applicability to various opposed electrode welding processes, including spot, seam and stitch welding, it has particular applicability to what is commonly referred to as resistance spot welding and more specifically, spot welding utilizing welding robots. Accordingly, the preferred embodiment will be described with respect to a robotic weld system incorporating a “C” style spot welding gun as shown in FIG. 1 and a robotic weld system incorporating an “X” style spot welding gun as shown in FIG. 2.

Reference is first made to FIG. 1 showing a “C” style weld gun system 10 in accordance with the present invention. The weld gun system 10 of FIG. 1 includes an industrial welding robot 11 and a “C” style weld gun 12 connected thereto. The welding robot 11 includes an articulation arm comprised of one or more articulation joints 14, 15, 16 and one or more articulation links 18, 19, 20. As shown by broken lines in FIG. 1, the articulation joints 14, 15, 16 and the articulation links 18, 19, 20 are used to move the weld gun 12 to a variety of desired positions relative to a workpiece 13. The workpiece 13 normally comprises two or more metal components to be welded together. The welding robot 11 may comprise any conventional welding robot.

As shown in FIG. 1, the “C” style weld gun 12 is mounted to one end of the articulation link 20 and includes a main gun body 21, a welding or squeeze actuator 22, an equalization actuator 24 and a pair of welding electrodes 25 and 26. The electrode 25 is commonly referred to as the “stationary” or “fixed” electrode whose position is fixed relative to the main gun body 21 by the yoke 28. The electrode 26 is commonly referred to as the “moveable” electrode and is connected with the axially moveable actuator rod 29 of the squeeze actuator 22. In the preferred embodiment, the squeeze actuator 22 is an electrically driven, linear actuator of the type which is conventionally used in weld gun applications. In the preferred embodiment, the actuator 22 is a ball or roller screw type linear actuator which is electrically or servo driven. If desired, the welding actuator 22 may be any type of linear actuator which is now or hereafter used in weld gun actuation. The actuator 22 functions to axially move the moveable electrode 26 relative to the main body 21, and thus also relative to the fixed electrode 25, and to apply the welding pressure.

The equalization actuator 24, which will be described in greater detail below, is connected in a fixed position relative to the articulation link 20 via the bracket 23. The actuator functions to move the entire weld gun body 21, including the actuator 22, the yoke 28 and the electrodes 25 and 26 relative to the link 20 and relative to the workpiece 13. More specifically, as described below, the actuator 24 functions to move the electrode 25 toward the workpiece 13, detect contact between the electrode 25 and the workpiece 13, and thereafter maintain substantially equal pressures of the electrodes 25 and 26 against the workpiece 13. The equalization actuator 24 of the present invention is a fully integrated servo driven linear actuator and control system incorporated into a common housing.

The welding gun system 27 of FIG. 2 is similar to that of FIG. 1 except for the particular style of the weld gun. Specifically, the system of FIG. 2 includes an industrial welding robot 30 including one or more articulation joints 31,32 and one or more articulation links 34,35. The “X” style weld gun 36 is connected with an end of the articulation link 35 and includes a main gun body 38, a welding or squeeze actuator 39, an equalization actuator 40 and a pair of welding electrodes 41 and 42. The welding electrode 41 is the “stationary” or “fixed” electrode whose position is fixed relative to the main gun body 38 via the yoke member 44. The electrode 42 is the “moveable” electrode which is connected to the actuator rod 45 of the actuator 39 via the yoke 46 and is moveable relative to the gun body. As shown, the yoke 46 is pivotally connected with the main body 38 at the pivot point 48. The end of the yoke 46 opposite the electrode 42 is connected with the axially moveable rod 45. Thus, axial movement of the rod 45 will cause the electrode 42 to move toward and away from the workpiece 13 as the yoke 46 pivots about the pivot point 48. As with the weld system of FIG. 1, the equalization actuator 40 is fixed to an end of the articulation link 35 and functions to move the entire gun body 38, including the actuator 39 and the electrodes 41 and 42, relative to the workpiece 13. As described with respect to FIG. 1 and as will be described in greater detail below, the equalization actuator 40 is a fully integrated servo driven linear actuator with the driving and control components in a single housing.

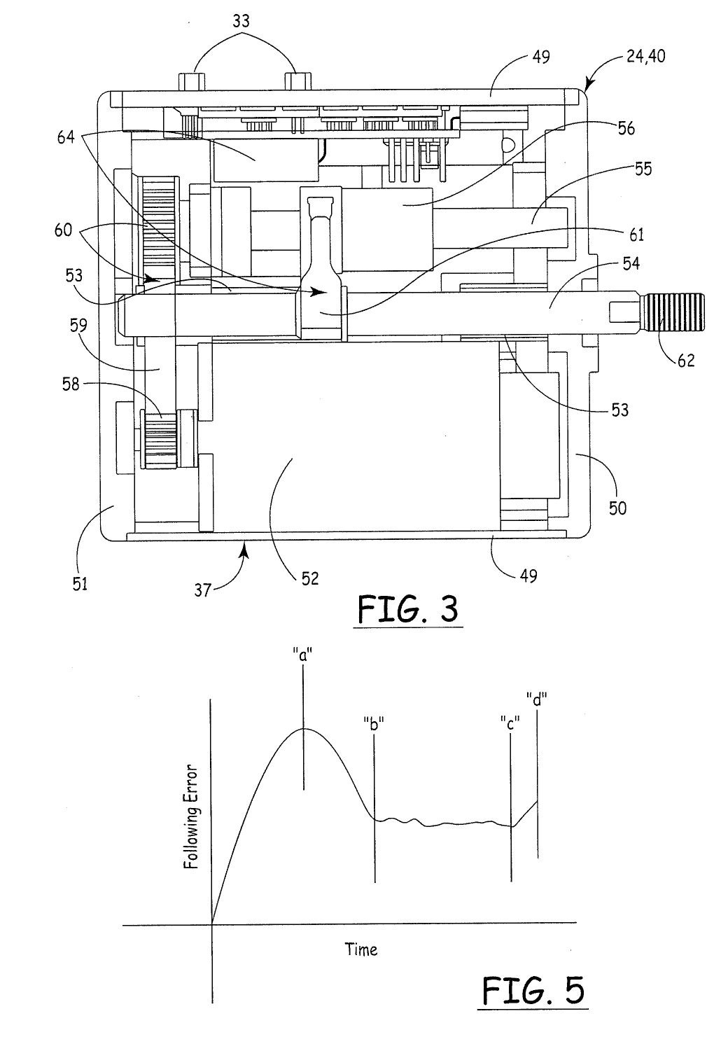

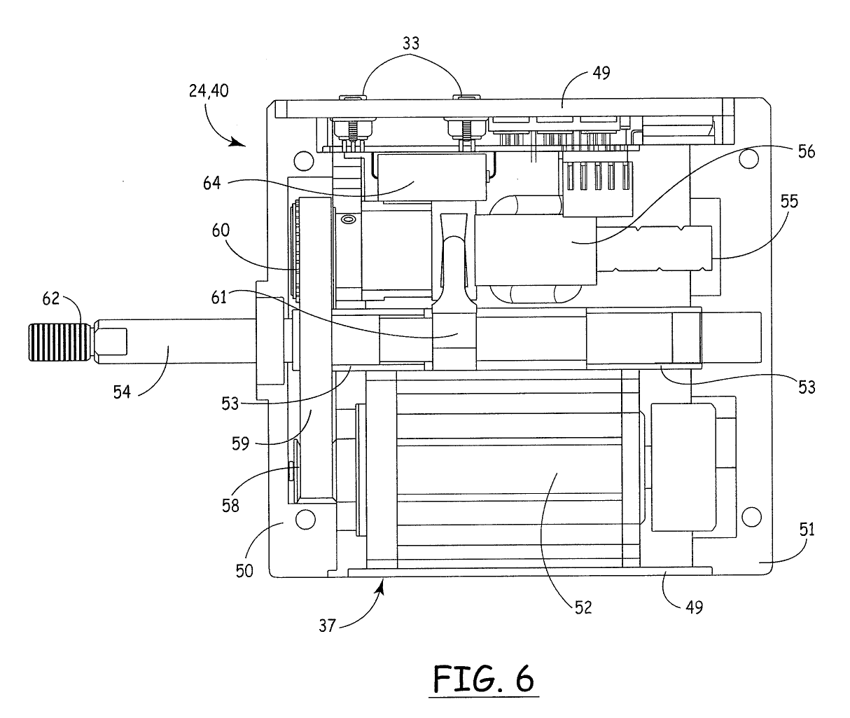

Reference is next made to FIGS. 3 and 6 showing the internal driving and control components of two embodiments of the equalization actuator 24 of FIG. 1 and the equalization actuator 40 of FIG. 2. Both embodiments of FIGS. 3 and 6 include the same functional components, but in some cases slightly rearranged. Accordingly, the functional components in both embodiments are given the same reference characters. The equalization actuator 24,40 of both FIGS. 3 and 6 is an integrated linear actuator, motor, driver, controller and feedback and includes an outer housing 37 comprised of the generally cylindrical side wall 49, the front end cap 50 and the back or rear end cap 51. As shown, end caps 50 and 51 are connected to opposite ends of the side wall 49 to form the housing 37. The housing 37 houses the driving and control components of the equalization actuator 24,40 and includes a pair of ports 33 to provide power and signal capability to the drive and control components. Within the housing 37, the equalization actuator 24,40 includes a servo driven linear actuator comprised of a servo motor 52, a linear actuator rod 54 and a ball screw mechanism comprised of the externally threaded rotatable rod 55 and the internally threaded non-rotatable nut 56.

In the preferred embodiment, the servo motor 52 is a conventional brushless, servo motor mounted within the housing 37. An output shaft 58 of the motor 52 is connected via the transmission belt 59 to a driving end 60 of the ball screw rod 55. Accordingly, rotation of the servo motor 52 via the belt 59 causes corresponding rotational movement of the ball screw rod 55. In the preferred embodiment, the rod 55 is an externally threaded ball screw rod which is axially fixed relative to the actuator housing. In contrast, the ball screw nut 56 is rotationally fixed, but axially moveable relative to the actuator housing 37. The nut 56 includes internal ball screw threads which are engageable with the external threads of the rod 55. Thus, rotation of the rod 55 via the servo motor 52 results in axial movement of the nut 56 along the rod 55. A rod coupler 61 connects the nut 56 to the actuator rod 54. The actuator rod 54 is mounted within the actuator housing 37 to permit axial movement of the rod 54 in response to axial movement of the nut 56. Axial movement of the rod 54 is guided by the guide bushings 53,53. The outer end 62 of the actuator rod 54 extends outwardly from the housing 37 and is provided with threads or other means for connection to the main body of the welding gun.

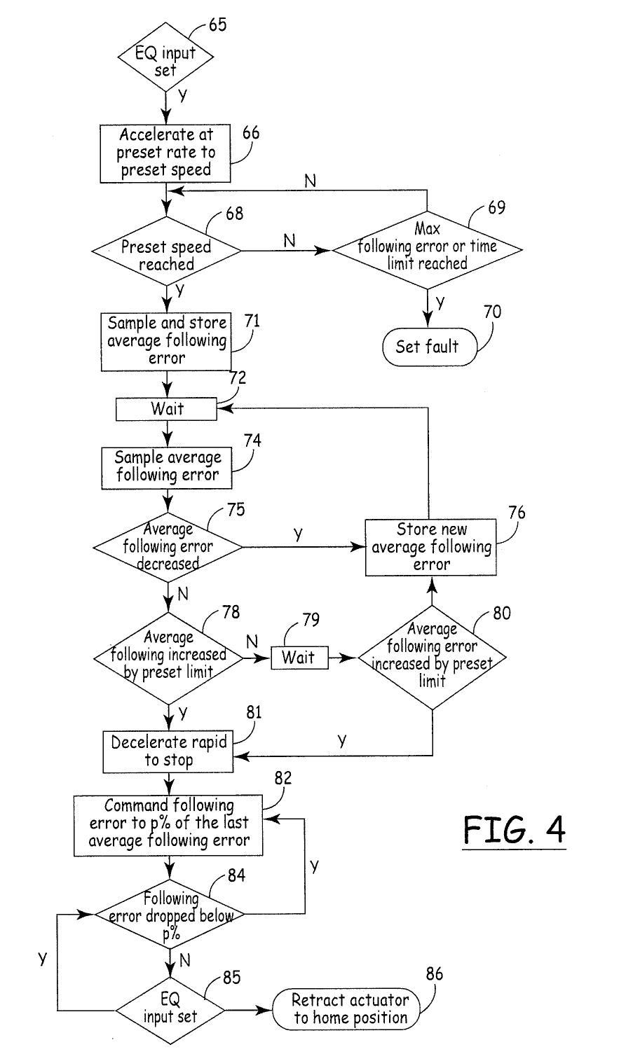

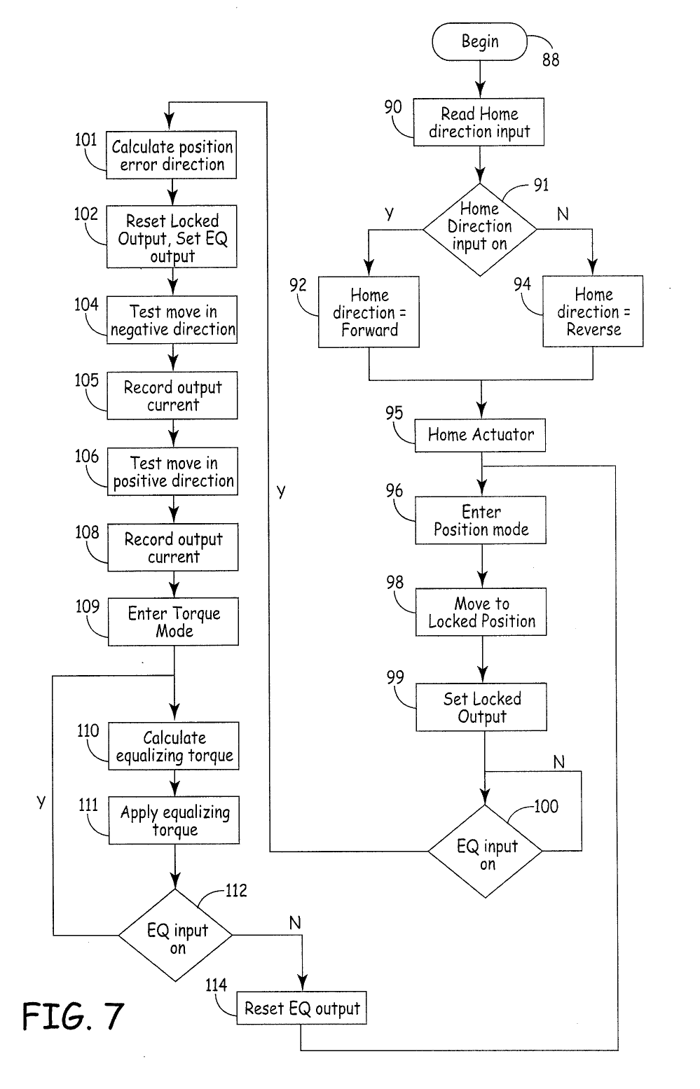

The controller/amplifier 64 is a conventional controller for the brushless drive servo motor 52 which is programmed to control the motor 52, and thus the actuator 24,40 in accordance with one of the processes as described below and shown in FIGS. 4 and 7. This controller 64 is dedicated to the servo motor 52 and is programmed, and thus functions, to control the motor 52 in accordance with one of the methods described below. Accordingly, all that is needed for operation of the equalization actuator 24,40 shown in FIG. 3 is 24V dc power and a command signal to initiate/release the equalization process as described below. By integrating all of the driving and control components in a single device or housing, retrofits to existing pneumatic systems are simple. All that is required for operation is 24V dc/5 amp power and, for example, the same equalization signal that previously triggered the pneumatic valve in a pneumatic system.

During operation of the weld gun systems of FIGS. 1 and 2, the fixed and moveable electrodes of the weld gun are spaced from one another and the workpiece 13 or components to be welded are positioned between the electrode tips. The electrodes are then moved toward opposite sides of the workpiece via actuation of the equalization and squeeze actuators in accordance with one of the methods described below so that the electrode tips are properly positioned and in contact with opposite sides of the workpiece and the pressures applied by the electrodes against the workpiece are substantially equal. In accordance with the present invention, this is accomplished by actuating the equalization actuator 24,40 and the squeeze actuator with a motion profile and sequence to first allow contact of the fixed electrode with one side of the workpiece and then bringing the moveable electrode into contact with the opposite side of the workpiece 13. The welding pressure is then applied and contact of the fixed electrode with the workpiece 13 is maintained so that forces of the moveable and fixed electrodes against the workpiece are substantially equal.

In general, one embodiment of a the method in accordance with the present invention provides for positioning the fixed electrode relative to the workpiece and equalizing electrode forces against the workpiece in an opposed electrode welding apparatus. The method of this embodiment accomplishes this by monitoring the following error of the servo driven equalization actuator and controlling the servo driven actuator in response to or based on such following error. Following error or position error is fully understood by those familiar with servo technology and is the difference between the position where the controller has commanded the device (the servo motor) to be at a specific point in time and the position where the device actually is at that point in time. The following error is proportional to the load applied to the device. In the method of the present invention the servo drive of the equalization actuator, and thus the fixed electrode, is accelerated at a preset rate to a preset speed. During this acceleration, the following error of the device continues to increase until the preset speed is reached, at which time the following error will decrease until it reaches a stable or constant level needed to maintain the device at that preset constant speed. After the preset speed has been reached, the following error of the device is continually monitored by the controller. When the fixed electrode makes contact with the workpiece, the following error will immediately spike or increase beyond a preset limit because of the resistance of the workpiece to further movement of the fixed electrode. Because the following error is being monitored, this increase can be immediately detected. When this occurs, power to the device is stopped, and thus movement of the fixed electrode is stopped. Detecting a spike or increase in the following error precedes any detection of an increase in the power or current needed to maintain the device at the preset speed and thus provide a quicker and more responsive means of detecting contact between the fixed electrode and the workpiece.

The relationship between the following error during this workpiece locating phase in the process of the present invention can be shown schematically in the graph of FIG. 5 which plots the following error on the vertical axis against time on the horizontal axis. Prior to the equalization command, the servo motor, and thus the fixed electrode, is at rest. Thus, both time and the following error are zero. When an equalization command is received, the servo motor, and thus the fixed electrode, is accelerated at a preset rate to a preset speed. During this acceleration phase which is shown on the graph of FIG. 5 in the area between the vertical axis and the vertical line “a”, the following error increases.

At the point indicated by vertical line “a”, the preset speed has been reached. After this, the following error begins to decrease and continues decreasing until vertical line “b” is reached, at which time the following error will stabilize and remain relatively constant. This is the following error which is needed to maintain the movement of the driver, and thus the fixed electrode, at the preset speed and is reflected by the area in the graph of FIG. 5 between the vertical line “b” and the vertical line “c”. As soon as the fixed electrode contacts the workpiece, the following error will immediately spike or increase as shown by the vertical line “d”. This condition is immediately detected and the motor is brought to a rapid stop, thereby also stopping movement of the fixed electrode. This may be by stopping power to the motor, or in some cases, by applying a negative current to the motor.

The equalization actuator in accordance with the present invention and this method embodiment also functions to maintain the fixed electrode in contact with the workpiece and to substantially equalize electrode forces against the workpiece as the moveable electrode contacts and presses against the opposite side of the workpiece. This is the equalization or forward bias phase of the process of the present invention. Pursuant to this method embodiment, this is accomplished by providing the equalization actuator with a forward bias so that if or when a force of the moveable electrode is applied to the opposite side of the workpiece, the fixed electrode will tend to continue forward movement so as to equalize the pressure of the two electrodes on opposite sides of the workpiece. This forward bias is provided by commanding movement of the device to a preset percentage of the last determined following error.

The detailed method steps of this embodiment for detecting contact between the fixed electrode and the workpiece and maintaining a forward bias on the fixed electrode against the workpiece so as to equalize the electrode force are set forth in FIG. 4 showing a flow chart of the method. This is the control process or method carried out by the controller 64 (FIG. 3) of the equalization actuator 24,40 to control movement of the fixed electrode. First of all, on power up, the equalization actuator 24,40 can be set to automatically enable, allowing retrofits, without requiring an additional input to be added from pneumatic systems. In the preferred embodiment, the actuator 24,40 has a separate 24 volt DC supply for the control and for the servo drive. The actuator 24,40 will then be checked for connection to the follower inputs to determine if it is to function as a master or follower for a tandem equalization operation. Next, the actuator will automatically home or wait for a home command signal, based on a switch or jumper setup. The direction of homing is established by the wiring method of the control cable. Homing consists of extending or retracting a preset following error, at which point the device moves in the opposite direction a preset, short distance off the hard stop. This position is then defined as “home”.

Once the homing is complete, the actuator waits for an equalization command. This is shown in FIG. 4 by the step 65. If and when the equalization command (“EQ input set”) is received, the servo motor 52 (FIG. 3) will accelerate at a preset rate to a preset speed as shown in step 66. This preset rate and preset speed are programmed into the controller 64 (FIG. 3). The time required to accelerate can vary according to the particular application and circumstances; however, it is expected that this acceleration to the preset speed would occur very rapidly, on the order of 100 milliseconds or less. As described with respect to FIG. 3, this acceleration and rotation of the motor 52 causes corresponding acceleration and linear movement of the actuator rod 62, and thus the fixed electrode 25,44 (FIGS. 1 and 2) of the weld gun.

During this acceleration, the controller 64 (FIG. 3) will continually check to determine whether the preset speed has been reached as shown in step 68. If not, a determination will be made as to whether the following error of the servo has exceeded a certain preset or predetermined level or whether a preset or predetermined time limit has been reached as shown in step 69. If neither of these is satisfied, the controller will cycle back and again determine whether the preset speed has been reached as in step 68. If, as in step 69, the following error exceeds the preset maximum or the preset time limit is reached, a fault will be indicated as in step 70 and power to the drive will be stopped. Exceeding the maximum following error or reaching the time limit will usually mean that the electrode has hit something in its path that is not suppose to be there, that there is some other fault in the system which has caused the time limit to be reached before the preset speed has been reached, or the workpiece is missing or the gun was misaligned such that the workpiece is out of the reach of the welding gun. In the preferred embodiment, movement to step 70 would indicate a fault in the system and require someone to determine the reason for the fault. Alternatively, if the following error exceeds the preset maximum before the time limit is reached, it may be an indication that the workpiece or target has been located prematurely and the system can be programmed to simply skip the workpiece location phase and proceed automatically to the forward bias phase of steps 82, 84 and 85.

Once the preset speed has been reached as in step 68, the device will go into a workpiece location phase which begins by monitoring the following error of the servo drive. In the preferred embodiment, this is accomplished by sampling and storing averages of moving sets of following error and comparing the most recent following error average to the stored following error average. Specifically, a first set of following error is sampled, averaged and stored as in step 71. This is followed by a short time interval as in step 72 (which may be on the order of about five milliseconds) which is followed by a further set of following error being sampled and averaged as in step 74. These following error averages can take a variety of forms. For example, the following error averages could be the averages of the following error sets over succeeding time intervals (such as five milliseconds) or they could be running following error averages with each succeeding average determined by adding the next following error in a set and deleting the last following error in the set.

After the second average following error is determined in step 74, this second average following error is compared to the stored average following error of step 71. This comparison is done in step 75. If the average following error of step 74 is less than the stored average following error of step 71, the average following error of step 74 is stored as the new average following error as in step 76. This decrease in average following error confirms that the preset speed has been reached and that contact of the fixed electrode with the workpiece has not yet been made. Accordingly, the process will cycle back to the “wait” step 72, after which a further average following error will again be determined in step 74. This further average following error will then again be compared (in step 75) to the new stored average following error and the cycle will continue as long as the average following error determined in step 74 is decreased compared to the stored average following error of step 76 or 71.

If the average following error of step 74 is not less than the stored average following error of step 71 or step 76, a determination will be made in step 78 whether the average following error is increased over the stored average following error by a preset limit. This is the step which will ultimately indicate whether the workpiece has been contacted by the fixed electrode. Because of tolerances, frictional forces, etc. in the system, not all increases in the following error (particularly small increases) will necessarily indicate that contact with the workpiece has been made. However, an increase in the average following error over a certain preset limit will indicate that such increase is a result of contact with the workpiece. In general, an increase in the preset limit of step 78 will require a harder or more forceful contact between the electrode and the workpiece before contact is confirmed. Thus, the particular preset limit will depend on a variety of factors including the level or degree of contact to be made before contact is confirmed. This limit should preferably be set so that contact is confirmed prior to either the electrode or the workpiece being damaged. Accordingly, it is expected that in many cases, the preset limit could be about 10% to 20% above the last stored average following error. If the average following error does not increase by the specific preset limit specified in step 78, a time interval (which again may be on the order of about five milliseconds) is allowed to elapse as in step 79. A new average following error is then determined and compared to the stored average following error as in step 80. If the average following error is not increased by the preset limit, the method cycles back to step 76 where the average following error of step 80 is stored as the new stored average following error and the method cycles back to step 72 where the cycle repeats itself.

If the average following error determined in step 78 or in step 80 is increased by the preset limit over the stored average following error, this indicates that contact with the workpiece has been made and movement of the servo motor, and thus the fixed electrode, is immediately stopped as in step 81. Such movement may be stopped by stopping power to the motor or, in some cases, by applying a negative current to the motor. At this point, contact between the fixed electrode and the workpiece has been made and any forward or further movement of the fixed electrode toward the workpiece has been stopped.

The remaining steps 82, 84 and 85 in the method then provide a forward bias to the fixed electrode in the direction of the workpiece so that any corresponding force of the moveable electrode against the workpiece from the opposite direction will cause the fixed electrode to follow along or advance in a manner which maintains contact with the workpiece and substantially equalizes the forces of the moveable electrode and the fixed electrode against opposite sides of the workpiece.

In step 82, the controller commands the position, and hence the following error, to a preset percentage of the last stored average following error. The last stored average following error (i.e., 100% thereof) is an approximate representation of the following error at the then current gun orientation, with approximate frictional and other external forces. However, adjustment must be made to overcome the effects of following error in a static condition vs. a dynamic condition as it was when the following error was collected, and thus the last stored average following error determined. The “balancing” force provided during this phase of operation should preferably be approximately equal to the force required to advance the gun forward if the workpiece and moveable tip were not present to resist motion. It is not necessary that this force be exact because as the moveable electrode contacts the opposite side of the workpiece and exerts a force thereon, either during initial contact or during pressing or welding actuation, that force will be resisted via the main gun body, and thus the fixed electrode, thereby providing the assistance needed to advance the fixed electrode to substantially balance the force of the moveable electrode. This command to a preset percentage of the last stored average following error will provide a forward bias to the fixed electrode and, to the extent the moveable electrode exerts a force on the opposite side of the workpiece, will tend to cause the fixed electrode, and thus the entire main weld body to move in the direction of the workpiece, thereby substantially equalizing pressures of the moveable and fixed electrodes on opposite sides of the workpiece.

Alternatively, the forward bias to the fixed electrode may, if desired, be provided by applying a fixed current to the motor rather than commanding the position to a percentage of the last stored following error average. This fixed current would preferably be the current needed to provide the “balancing” force, namely, the force equal to that force needed to advance the gun forward if the workpiece and moveable tip were not present to resist motion. This current level is approximately equal to the current applied to the servo motor just prior to contact of the stationary electrode with the workpiece. If desired, this fixed current may also be a percentage of this applied current.

Following the command of step 82, the following error will continue to be monitored as in step 84. If the following error drops below the preset percentage of the last stored following error average commanded in step 84, the controller 64 will continue to command the position/following error to the preset percentage of the last stored average following error as in step 82. If the following error determined in step 84 does not drop below the command following error of step 82, a determination is made in step 85 whether equalization has been commanded. If it has, the process returns to step 84 where the following error is again sampled and the process proceeds to step 82 or step 85 depending on whether or not it is less than the preset percentage of the last stored average following error. If equalization has not been commanded in step 85, the actuator is retracted to its home position as in step 86.

Accordingly, the above described process shown in the flow chart of FIG. 4 controls the equalization actuator 24,40 (FIGS. 1, 2 and 3) and thus the movement of the main weld gun body and the fixed electrode relative to the workpiece. Initially, after powering up and homing the equalization actuator, and after the workpiece has been positioned between the fixed and moveable electrodes, the equalization command is provided to the controller 64 (FIG. 3) of the equalization actuator and the method shown in FIG. 3 is carried out. According to this method, the equalization actuator accelerates the movement of the fixed electrode toward the workpiece at a preset rate until it reaches a preset speed. Once this preset speed is reached, the method continues with a workpiece location phase. This involves monitoring the following error of the servo drive to determine when contact between the fixed electrode and the workpiece is made. This is done by collecting and comparing moving sets of following error averages. As long as the following error averages continue to decrease, or not increase over a preset limit, contact between the fixed electrode and the workpiece has not been established. However, as soon as the average following error spikes or increases over such preset limit, this indicates that contact between the fixed electrode and the workpiece has been made and further movement of the fixed electrode is immediately stopped.

After the workpiece location phase, the method continues with a forward bias or equalization phase which assures that the forces of the moveable and the fixed electrodes on the workpiece are substantially equal. This is accomplished by the controller commanding the position or following error to a preset percentage of the last stored average following error. This last stored average following error is the average following error immediately prior to the increase in the average following error over the preset limit. This command of a preset percentage of the following error provides a forward bias to the fixed electrode. Thus, whenever the moveable electrode contacts the opposite side of the workpiece and exerts a force or pressure thereon, the forward bias of the fixed electrode, together with the force opposing the force of the moveable electrode, will cause the fixed electrode to follow or move toward the workpiece, thereby substantially equalizing the pressures or forces of the moveable and fixed electrodes against the workpiece.

A further embodiment of a method in accordance with the present invention for positioning the fixed electrode relative to the workpiece and for equalizing electrode forces against the workpiece in an opposed electrode welding apparatus is shown in the flow chart of FIG. 7. In general, this method involves determining the equalizing force or torque needed to maintain the fixed electrode in a predetermined position and applying such equalizing force or torque. This enables the main body of the weld gun, and thus the fixed electrode, to float relative to the workpiece. Thus, any external force such as that resulting from engagement of the fixed electrode with the workpiece or that exerted by the squeeze actuator and thus the moveable electrode against an opposite side of the workpiece, will cause the main body and fixed electrode to move in the same direction as such external force.

The detailed method steps of this embodiment of the equalization method are shown in the flow chart of FIG. 7. First of all, upon powering up and beginning (step 88), the homing direction has been input and the home direction is read in step 90. Depending on the home direction input that is read in step 90, the equalization motor, and thus the welding gun position will move to its home position in either the forward direction (step 92) or the reverse direction (step 94) in accordance with step 91. Step 95 indicates that homing is complete.

The desired or locked position is then entered in step 96 and the equalization actuator is moved to that position in step 98. The locked position defines the desired start position of the equalization actuator and is an arbitrary position that may be selected by the user or otherwise determined. Step 99 is an indicator which indicates or confirms that the equalization actuator is ready and in its locked or desired start position. Step 100 determines whether the equalization input is turned on. If it is not, the system will be maintained in this ready position with the actuator in its locked position, until the equalization input is activated. If the equalization input is turned on and is activated, the equalization process defined in steps 101 through 111 will begin. This equalization includes steps 101 through 108 which, while the actuator is still in its locked position mode, determines the information and data needed to calculate the equalizing torque, step 109 which terminates the locked position mode and enters the torque or equalizing mode, and steps 110 and 111 which involve calculating and applying the equalizing torque in the equalizing mode.

When in its locked or desired start position, various forces such as gravity, etc. may be acting on the weld gun and thus the equalization actuator. In step 101, the direction of the torque or force needed to keep the actuator from moving out of its locked position and to resist such external forces is detected. This locked position torque is either a torque in the forward or extended direction or a torque in the reverse or retracted direction. The direction of the torque can be calculated or determined by determining whether the position or following error of the equalization actuator motor is positive or negative in accordance with step 101. Step 102 is an indicator and merely indicates and confirms that the locked output has been reset.

Next, the actuator is moved in accordance with step 104 a short distance in the negative (retracted) direction and the current needed to maintain the actuator in the locked position against this movement (and thus the current needed to overcome this locked position) is recorded in step 105. In step 106, the actuator is moved a short distance in the position direction and the current needed to maintain the actuator is the locked position against this movement (and thus the current needed to overcome this locked position) is recorded in step 108. The torque or equalizing mode is then entered in step 109. This involves calculating the equalizing torque in step 110 and applying the equalizing torque in step 111. Calculation of the equalizing torque in step 110 in accordance with the preferred embodiment involves averaging the torque needed to keep the actuator in the locked position when a force in a negative direction is applied and the torque needed to maintain the actuator in the locked position when a force in the position direction is applied. This is the equalizing torque. This equalizing torque is then applied to the actuator in step 111 in the same direction as the locked position torque. Accordingly, the application of this equalizing torque maintains the actuator and thus the welding gun and fixed electrode in a “float” position.

This equalization force will continue to be applied as long as the equalization input or mode is turned on in accordance with step 112. If the equalization input is turned off, the equalization output will be reset in accordance with step 114 and the actuator locked position will be reestablished in accordance in steps 96, 98 and 99.

Accordingly, the method and embodiment of FIG. 7 provides a means for maintaining the welding gun and thus the fixed electrode in a “float” position so as to assure that the forces of the moveable and fixed electrodes on the workpiece are substantially equal.

During a welding process utilizing the equalization actuator assembly and the methods in accordance with the present invention, a robot carrying the weld gun and its associated equalization and squeeze actuators is positioned relative to a workpiece to be welded. Prior to contact of either of the fixed or moveable electrodes with the workpiece, the equalization mode of the equalization actuator will be activated. The robot will then normally move the weld gun so that the fixed electrode is in close proximity to one side of the workpiece. If such movement by the robot causes the fixed electrode to physically engage the workpiece, the equalization methods described above which cause the welding gun to float will prevent the fixed electrode from moving past this initial contact. Following this initial positioning of the fixed electrode, activation of the moveable electrode via the squeeze actuator will result in the moveable electrode engaging the opposite side of the workpiece. If during this engagement the fixed electrode is not engaged with the opposite side of the workpiece, the equalization method above, because of its ability to “float” the welding gun, causes the fixed electrode to move into engagement with the opposite side of the workpiece. When both electrodes are in engagement with the workpiece, the workpiece is welded.

Although the description of the preferred embodiment and method has been quite specific, it is contemplated that various modifications could be made without deviating from the spirit of the present invention. Accordingly, it is intended that the scope of the present invention be dictated by the appended claims rather than by the description of the preferred embodiment.

1. An electrode positioning device for an opposed electrode welding apparatus comprising:
a housing;
a servo driven linear actuator;
a controller operatively connected to said actuator; and
said actuator and said controller contained within said housing.

2. The equalization device of claim 1 wherein said servo driven actuator includes a servo motor and a linear screw actuator.

3. The equalization device of claim 2 wherein said servo driven actuator includes a drive rod and a rod coupler operatively connected between said linear screw actuator and said drive rod.

4. The equalization device of claim 1 wherein said controller includes control means for controlling movement of said servo driven actuator.

5. The equalization device of claim 4 wherein said control means includes means for monitoring the following error of said servo driven actuator.

6. An equalization actuator for an opposed electrode welding apparatus comprising:
a housing;
a linear screw actuator including an actuator rod rotationally fixed and axially moveable relative to said housing;
a servo drive including a servo motor, a drive nut and a drive rod, one of said drive nut and said drive rod being rotationally fixed and axially moveable relative to said housing and the other of said drive nut and said drive rod being axially fixed and rotationally moveable relative to said housing; and
a rod coupler operatively connected between said actuator rod and said one of said drive nut and said drive rod.

7. The equalization actuator of claim 6 wherein said screw actuator, said servo motor, said drive rod and said rod coupler are contained within said housing.

8. The equalization actuator of claim 6 wherein said screw actuator includes a longitudinal axis and said servo motor includes a rotational axis and wherein said screw actuator longitudinal axis and said servo motor rotational axis being substantially parallel to one another.

9. The equalization actuator of claim 6 wherein said one of said drive nut and said drive rod is said drive nut, said drive rod includes an axial movement axis and said axial movement axis is parallel to and positioned between said screw actuator longitudinal axis and said servo motor rotational axis.

10. The equalization actuator of claim 6 including a controller for the servo motor contained within said housing.

11. An opposed electrode welding system comprising:
a welding gun assembly comprising;
a gun body,
a stationary electrode fixed relative to said gun body,
a moveable electrode moveable relative to said gun body and said fixed electrode, and
a squeeze actuator operatively connected between said gun body and said moveable electrode and
an equalization actuator assembly operatively connected to said gun body comprising;
a housing,
a servo driven actuator,
a controller operatively connected to said servo driven actuator, and
said servo driven actuator and said controller contained within said housing.

12. A method of controlling movement of the electrodes in an opposed electrode welding apparatus comprising:
providing an equalization device with a servo driven actuator;
monitoring the following error of said servo driven actuator, and
controlling said servo driven actuator in response to a change in said following error.

13. The method of claim 12 including accelerating said actuator at a predetermined rate to a predetermined speed and controlling said actuator in response to a change in said following error after said acceleration.

14. The method of claim 13 including stopping or rapidly slowing movement of said actuator in response to an increase in said following error above a preset level.

15. The method of claim 14 including using the following error immediately prior to said stopping or rapidly slowing movement step to establish the follow-up positional command/following error or current/force limit.

16. The method of claim 12 wherein said monitoring step includes sampling and storing running averages of sets of following error.

17. A method of controlling electrode movement for a spot welding apparatus which includes a welding gun body and operatively connected first and second welding electrodes comprising:
providing a servo driven equalization actuator, said equalization actuator being operatively connected to the welding gun body and including a linear actuator and a servo motor;
applying an electric power level to said servo motor to accelerate said servo motor to a predetermined speed;
monitoring the following error of said servo motor; and
controlling the power level to said servo motor in response to a said following error.

18. The method of claim 17 including determining contact between one of said electrodes and a workpiece by detecting an increase in said following error.

19. The method of claim 18 including reducing the power level to said servo motor upon determining said contact.

20. The method of claim 17 including determining a first following error of said servo motor while said servo motor is at said predetermined speed and stopping or decelerating said servo motor when the following error of said servo motor increases to a predetermined level above said first following error.

21. The method of claim 17 including determining the following error applied to said servo motor following said acceleration and while said servo motor is at said predetermined speed.

22. The method of claim 18 including determining the following error prior to said increase in following error.

23. The method of claim 22 including commanding a position/percentage of said following error prior to said increase in following error.

24. The method of claim 23 wherein said percentage is less than 100%.

25. The method of claim 17 wherein said monitoring step includes sampling and storing running averages of sets of following error.

26. A method of controlling movement of the electrodes in an opposed electrode welding apparatus comprising:
providing an equalization device with a servo driven actuator;
defining a desired position for said actuator;
determining an equalization force needed to maintain said actuator in said desired position; and
applying said equalization force to said actuator.

27. The method of claim 26 wherein said determining step includes determining the direction of the force needed to maintain said actuator at said desired position.

28. The method of claim 27 wherein said determining step includes determining the current needed to move said actuator from said desired position in a negative direction and the current needed to move said actuator from said desired position in a positive direction.

29. The method of claim 28 including applying said equalization force in said direction.

30. The method of claim 26 wherein said determining step is based on the force needed to move the actuator from said desired position in a negative direction and the force needed to move the actuator from said desired position in a positive direction.

31. The method of claim 30 wherein said equalization force is the average of the force needed to move the actuator from said desired position in a negative direction and the force needed to move the actuator from said desired position in a positive direction.

32. The method of claim 31 including applying said equalization force in said direction.
